(19) United States
(12) Patent Application Publication
(10) Pub. No.: US 2007/0150611 A1
(43) Pub. Date: Jun. 28, 2007

(54) DNS based client-server system and its use in electronic devices

(76) Inventors: Davy Chan, Hong Kong (CN); Kwok-fung Wilson Shum, Hong Kong (CN)

Correspondence Address: KNOBBE MARTENS OLSON & BEAR LLP, 2040 MAIN STREET, FOURTEENTH FLOOR, IRVINE, CA, 92614, US

(21) Appl. No.: 11/319,310

(22) Filed: Dec. 28, 2005

(51) Int. Cl. G06F 15/16

(52) U.S. Cl. 709/230

(57) ABSTRACT

A system configured to expand the utility of DNS in a network is disclosed. A DNS command not only carries the host name for an application server but also a command name or reference and optionally one or more parameters for the command. In other words, a command may be parameterized by encoding the arguments into the domain name preceding the sub-zone. Thus, a client can make use of available server computing resources by issuing DNS commands to a network.

### BACKGROUND OF THE INVENTION

1. Field of the Invention

The present invention relates to a client-server system. In particular, it relates to a client-server computing environment which is based on and takes advantages of the well-established and widely-deployed network infrastructure: Domain Name Service (DNS) or a similar name registration system.

2. Background of the Invention

In a client-server computing environment where the client is of limited hardware resource and tight bandwidth availability, it is necessary for the client application to be built in a way that it produces minimum network traffic and demands as few resources as possible. An example of such environment is the networked consumer electronic device, which is essentially an embedded system that runs network aware applications.

With rapid advances in computer technologies and electronic engineering, an increasing number of consumer electronic devices are equipped with networking capability, which gives rise to the need for an effective way of building light-weight application protocols that run on such devices to effect an efficient client-server communication.

Furthermore, manufacturers of these networked consumer electronics are typically highly sensitive to manufacturing costs owing to the large volume of production and the severe price competition among competitors. Therefore, in addition to the network bandwidth constraint and the physical limitation such as the footprint and memory consumption, manufacturers' looking for cost reduction of consumer electronic devices intensifies the needs for creating a lean-and-mean communication scheme between the networked consumer electronic device and the servers in the network and for shifting heavy computation tasks towards the servers.

Domain Name Service (DNS) is a well-established and widely-deployed network infrastructure based on protocols and standards defined in a list of Request for Comments (RFCs) that are developed and maintained by the Internet Engineering Task Force (IETF). One of the most commonly used functions of DNS is to translate a human readable domain name into IP address.

Domain Name System is hierarchical in which a name server covering a larger namespace, or a DNS zone, delegates the resolution of a sub-zone to other name servers. For example, the name server tldl.ultradns.net is, among many other name servers, responsible for resolving the address under the DNS zone “org”, while the host “dns1.astri.org” is the name server responsible for resolving any address under the sub-zone “astri.org”. “dns1.astri.org” in turn may delegate the resolution further to another name server.

Since DNS names are more easily memorized and thus more user-friendly, DNS lookup is typically used in any network based application. In a typical scenario, a client would first, through a DNS stack, issue a query to a DNS server for the address of a name that represents the application server, such as a web server. The DNS server would respond with zero or more A Records (for IPv4) or AAAA and A6 Records (for IPv6) that contains the address of the corresponding name. The client then would use that address and issue an application request directly to the application server.

In addition to the need for an additional round trip to merely obtain the address of the application server, the client would need to be equipped with the protocol stack for application layer communication, such as, for example, the HTTP stack. To the manufacturer, application protocol stacks incur development cost and/or licensing cost, and impose additional requirements to the footprint and memory consumption. Also, design of proprietary protocols that are developed in-house would need solutions for security, scalability and other network issues. The conventional DNS communication scheme therefore is not suitable for application clients distributed or embedded on networked consumer electronic devices or other situations where hardware resources are tight and the bandwidth availability is limited.

### SUMMARY OF THE INVENTION

It is thus advantageous to establish a cost effective generic framework for client-server based applications running on top of networked consumer electronics devices based on the existing Internet infrastructure DNS or another name registry system, such as, for example, Windows Active Directory, Universal Description, Discovery, Integration (UDDI), used alone or in combination.

This and other advantages are achieved with a method and system where resource demand is greatly reduced on the client side by encoding the application command into a DNS query and by reusing well-defined and widely-deployed DNS protocols.

The DNS query that contains a reference to an application command is referred to as “DNS Command.” A DNS command is in exactly the same format as a standard DNS query, i.e., it comprises a plurality of phrases or words separated from each other by a “dot” or other symbols. Although a DNS command looks no different from a stand DNS query, between them lie an important difference. Unlike a standard DNS query which basically carries the host name for an application server and asks the IP address of the host, a DNS command not only carries the host name for an application server but also a command name or reference and optionally one or more parameters for the command. In other words, a command may be parameterized by encoding the arguments into the domain name preceding the sub-zone. Further, a DNS command does not ask for an IP address as the return, but asks for execution of the command with optionally returning the execution result.

To handle the DNS command, a special DNS server which is referred to as “C-DNS server” may be used. A C-DNS server is a standard DNS server with additional functionality so as to have an ability to recognize a DNS command and process it differently than a standard DNS query. Without a C-DNS server, a DNS command would elicit an error message to the effect that “no such host can be found.” A C-DNS server is typically responsible for one (or more) particular sub-zones such that any DNS command that contains a reference to the namespace of the sub-zone will be recognized as a DNS command, not an IP address query, which may then trigger a sequence of actions including, but not limited to, database access through a database server (query, update, etc), execution of a computational task, or formulating a request of a different protocol to another application server, to name just a few.

### BRIEF DESCRIPTION OF DRAWINGS

FIG. 1 is a flow chart showing processing of developing an application with the DNS command.

FIG. 2 is flow chart showing processing of a DNS query request from a client by the DNS command server.

FIG. 3 shows deployment setup of an application with a DNS command.

FIG. 4 shows deployment setup of an application with another DNS command.

### DETAILED DESCRIPTION OF THE INVENTION

As an exemplary embodiment of the present invention, assuming that the sub-zone “command.astri.org” is dedicated for DNS command based application and the name server NS1 (which is a C-DNS sever) is responsible for the sub-zone, the following captures a sequence of actions performed by the client and the C-DNS server NS1.
a. The client sends DNS Query of TXT Resource Record for the name: “2.2.add.math.command.astri.org”—a DNS command in the form of a standard DNS query;
b. NS1 recognizes that it is not an ordinary DNS query, but a DNS command and ensures that it will go to the “math” sub-zone;
c. NS1 passes the command to the math-handler, a module responsible for execution of the arithmetic calculation referenced to by the part of domain name “add.math” in the DNS command. The module may be part of an application server sitting on the same host with NS1 or on anther host and it may pass the task to another module (a delegate) on the same host or on a different host;
d. The math handler or its delegate interprets “2.2.add” (part of the DNS command) as the expression “2+2” and performs the calculation to produce “4” as the result;
e. The math-handler returns the result (“4”) in the TXT Resource Record as a DNS Response; and
f. The client receives the DNS response and interprets the result not as an IP address but as a predefined meaning when the DNS command is defined.

The same method may be used in various scenarios. More useful applications of the method may include acquiring and releasing circuit-switched network proxy exchange point (Rendezvous Point) for network connectivity with “[more_application_parameters].[identifier].rv.command.astri.org”, and “[more_application_parameters].[identifier].rrv.command.astri.org”; querying for the shows from Electronic Program Guide for cable TV with “[more_application_parameters].[timeslot].[channel].epg.command.astri.org”; initiating a SIP call with “[more_application_parameters].[callee id].sip.command.astri.org”; or getting stock quote with “[more_application_parameters].[stock_code].stock.command.astri.org.”

The foregoing are provided by way of example, not limitation. People with ordinary skill in art may apply the present invention to other scenarios to obtain satisfactory results.

As it can be appreciated from the foregoing description, the method has a number of advantageous features inherited in or extended from the Domain Name System, which would otherwise need to be catered for by the application server itself (see RFC 1034 and 1035 for details unless for otherwise specified, which are each incorporated herein by reference.).

Flexibility

The DNS Command is multiplexed by further sub-zones, therefore each C-DNS server may process any number of DNS commands; When any one particular command gets so popular it can easily be migrated to a dedicated name server (C-DNS server) that handle just the sub-zone corresponding to the command, which is shield off completely from the users (clients).

Discovery

Commands supported by any specific C-DNS server, and their corresponding technical specifications are typically communicated between the service provider of C-DNS and the application developers prior to system integration. Optionally, this information may be captured from within the same DNS Command infrastructure. As an example, a list of commands supported by the “command.astri.org” C-DNS server may be retrieved by querying for a TXT Resource Record of the name “list.meta.command.astri.org” where each TXT Resource Record contains the name of the command, description of the command, and the location of the technical specification. Similarly, the technical specification of a specific command “<command>” may be retrieved at “<command>.meta.command.astri.org”. Implementation to the meta command can either be a retrieval of a static document, or a dynamically generated file according to the currently loaded modules in the C-DNS server.

Security

Security may be added into the application server optionally by simply adopting the DNS SEC specification (see RFC 2535, which is incorporated herein by reference.).

Cache

Caching may be achieved by manipulating the Time to leave field (TTL) of the DNS response. The actual value to be set for TTL varies according to the nature of application, the value being larger if the application is basically an information retrieval and the data is rather static (e.g. downloading the programming schedule (i.e. Electronic Program Guide for Cable TV) from the corresponding TV station's application server. There are other situations which require “No Cache.” No Cache may be easily achieved by setting the TTL to zero and thus force the request to always come to the authoritative DNS server of the zone, which is desirable for application that is dynamic in nature, such as setting up a SIP call, or acquiring a Rendezvous Point.

Scalability

Scalability is easily supported by adding more C-DNS servers to the server farm, and inserting corresponding NS records in the zone file accordingly.

Load Distribution

Load distribution is achievable, for example by implementing round robin to the multiple A records (for IPv4) or AAAA and A6 records (for IPv6) corresponding to the DNS command servers (see RFC 3596 for AAAA records, and RFC 2874 for A6 records, each of which is incorporated herein by reference.).

Although the foregoing description makes specific references to the Domain Name System, these general concepts are applicable to any name registry system, including but not limited to Windows Active Directory, Universal Description, Discovery, Integration (UDDI). Based on the description, people with ordinary skill in the art may reduce the inventive concepts to practice with other name registry systems, as well.

The following describes an exemplary method involved in implementing a client-server system. The system comprises a client, a network having a number of DNS servers (including standard name servers and C-DNS servers) and one or more application servers, where both the client and the application server have means for connecting to the network. The network and the connection thereto from the client and application server may be wired and/or wireless. The client can be any module (implemented in hardware, software or combination of both) that can send out a DNS query (and DNS commands) and process a return in a predefined Resource Record format. It includes, but is not limited to, a distributed micro-processing system with a network interface embedded on equipment or machines (such as those in scientific and technical research laboratories or manufacturing facilities), household appliances (such as the refrigerator, oven, microwave oven, coffee brewer, dishwasher, washing machine, dryer, TV set, etc), or mobile device (such as the mobile phone, GPS, PDA, etc), to name just a few. The application server, typically implemented in software or combination of software and hardware, can perform a plurality of computational tasks in response to a client request and provide the result to the client. The application server is either hosted in a separate a computer system or in the same computer system that also hosts the C-DNS server. A computer system typically is a device having a CPU and memory module to run software applications.

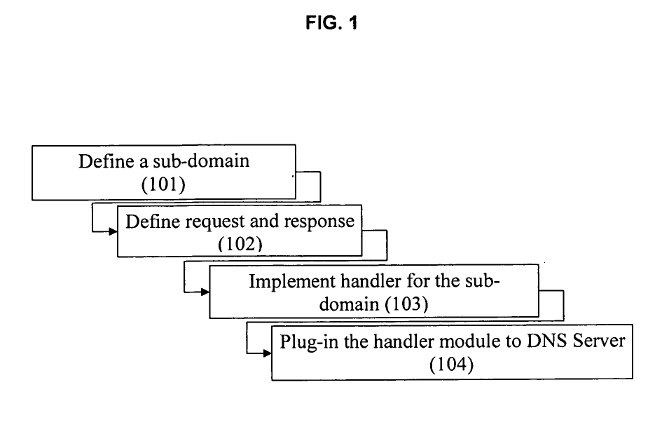

The first step is to define and implement a DNS command (or a sub-domain, step 101, FIG. 1). As described previously, the DNS command looks similar to a regular DNS query, comprising a number of phrases separated by “dots.” The DNS command contains two parts. The first part, processed the same way as a standard DNS query, contains the information that ensures the DNS command will be routed to the correct C-DNS server that has implemented the corresponding handler for the application command. The second part contains information related to the application command which may or may not include one or more parameters. However, the entire DNS command is in a format that is compatible with the existing DNS protocols so that the DNS command is treated like any other ordinary DNS query until it reaches the C-DNS server. It is believed that the design and implementation of a DNS client that can send a DNS query/command and receive a response in a Resource Record is known and within ordinary skill of a person skilled in the art. DNS clients are typically built-in under different programming environments. Otherwise, an ordinarily skilled person in the art is capable of developing one from scratch on a specific platform according to the DNS specifications. It is also believed that there is no need to further describe the process that enables the DNS command to reach the C-DNS server because it may be handled in the same way as any other DNS query is handled.

The second step is to define a Resource Record to return the result from execution of an application command in the application server (step 102, FIG. 1) to the DNS client. The type of Resource Record determines what information may be embedded into the response. This is application specific and is subjected to the design decision of the application developers. In general, the TXT Resource Record is flexible since it allows for any arbitrary text. Parsers may then be required to extract the result from the TXT. Other useful types of Resource Record include A (AAAA or A6 for IPv6), SRV, and CNAME which returns an IP, host and port, and a name, respectively. These are particularly useful for the application that expects results that are essentially in the form of some network resources. RFC 1035 defines the response code (RCODE) in DNS header which is a 4 bit field, the value 0 to 5 are defined as “No error”, “Format error”, “Server failure”, “Name Error”, “Not Implemented”, and “Refused” respectively, with the value 6-15 being reserved for future use. These codes should be sufficient for many applications to define errors

With the DNS command (in the form of a sub-domain name) and returned result format are defined in steps 101 and 102, the next step (step 103, FIG. 1) is the implementation of the software logic that handles the task referenced by the command. Specifically, each task referenced by a DNS command can be configured as a self-contained DNS zone. This zone can then be configured to use the corresponding handler. In BIND 9, a handler may be implemented with the BIND Simple Database (SDB) interface. Of course, other implementations may also provide satisfactory results.

Next step (step 104, FIG. 1) is to plug-in the handler to the C-DNS server. This can be achieved by specifying the name of the handler in the zone configuration file (by default, the /etc/named.conf). In addition, the name server implementation needs to be recompiled with the newly added handler along with the codes that initiate the handlers. More information on building an SDB module is available from the related DNS documentations. Of course, other methods of configuring the handler on the C-DNS server may be designed by the person with ordinary skill in the art.

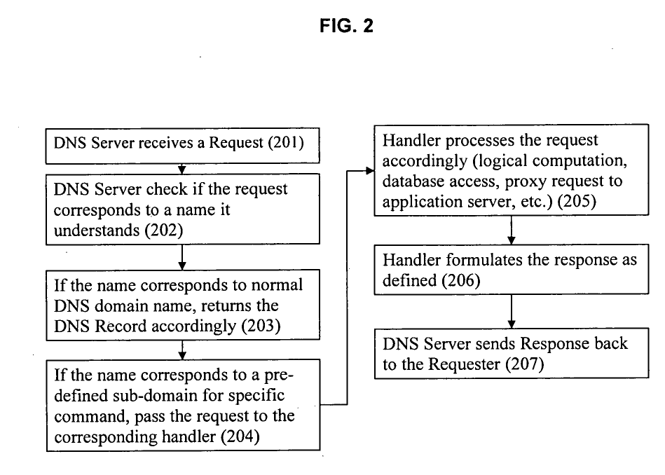

FIG. 2 shows a flow by which a DNS command can be processed by the C-DNS server. When the C-DNS server receives a DNS command (step 201), the server checks if the request corresponds to a name it understands (step 202). If the name corresponds to a normal DNS domain name, the C-DNS server performs conventionally and returns the DNS Record (containing the IP address) (step 203). However, if the DNS command corresponds to a pre-defined sub-domain for a specific command, the C-DNS server passes the command to the corresponding handler (step 204). An example of such handling is the BIND 9 implementation, where it is taken care of by the SDB framework. The mechanism being that when BIND 9 finds a match to the zone, the corresponding DB is loaded. Using BIND 9 for example, the handler means a specific implementation of SDB. For passing the command to its corresponding handler, the C-DNS server has a zone-to-sdb mapping defined in a zone configuration file. The handler invokes a proper module (the actual handler) to process the request accordingly (step 205) to produce a result, which is formulated according to a predefined Resource Record format (step 206) and passed back to the client as a DNS Response by the C-DNS Server (step 207).

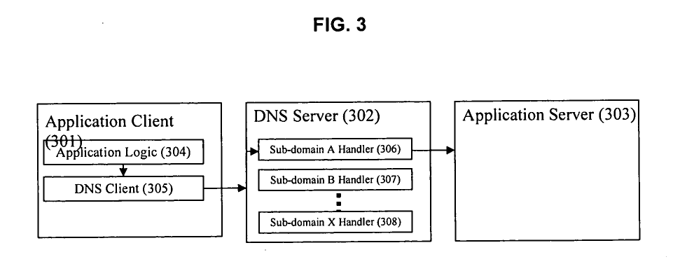

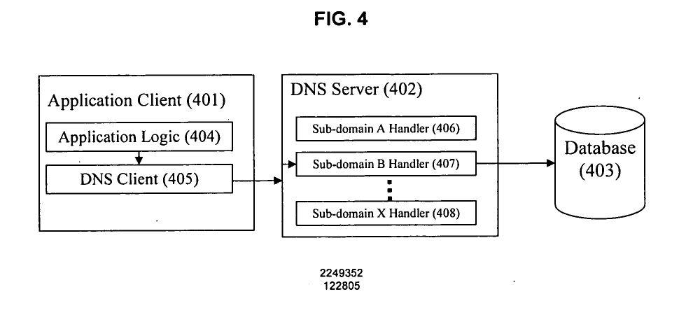

FIG. 3 and FIG. 4 show possible deployment setups of a system, where one DNS server (302 or 402) may define more than one handler (306-308, 406-408). Or, in other words, it is responsible for more than one sub-zone. The handler may be attached to other application servers (303 in FIG. 3) which provides the actual computational services or an external database server (403 in FIG. 4) for query or update a database.

For the purpose of constructing the claims annexed to this disclosure, the terms “DNS server”, “C-DNS server”, “DNS command”, “DNS response” encompass their counterparts in other name registration systems, such as, for example, Windows Active Directory, Universal Description, Discovery, and Integration (UDDI). The term “application server” means any computation module (implemented in software, hardware or combination of both) that can take a command or request, execute the task referenced in or specified by the command or request, and optionally return the execution result.

While there have been described and pointed out fundamental novel features of the invention as applied to preferred embodiments thereof, it will be understood that various omissions and/or substitutions and/or changes, in the form and/or details of the embodiments, may be made without departing from the spirit of the invention. The invention is not limited by the embodiments described above which are presented as examples only but can be modified in various ways within the scope of protection defined by the appended patent claims.

What is claimed is:

1. A client system comprising a network connection, a sender and a receiver; said sender being configured to send a DNS command over said network connection to a C-DNS server, the C-DNS server being configured to provide a response to said receiver.

2. The client system of claim 1, wherein said DNS command is in the same format as a standard DNS query, which comprises a plurality of phrases separated from each other by a dot or another symbol.

3. The client system of claim 2, wherein said DNS command contains a first piece of information and a second piece of information; said first piece of information allowing said DNS command to be routed to a C-DNS server that comprises a handler configured to process a command referenced in said second piece of information.

4. The client system of claim 3, wherein said handler is attached or linked to an application server.

5. The client system of claim 4, wherein said application server is a database server.

6. A method for a client to request a service from an application server, the method comprising sending a DNS command which contains a first piece of information and a second piece of information, wherein said first piece of information allows said DNS command to be routed to a C-DNS server, the C-DNS server being configured to execute a command referenced in said second piece of information through a handler.

7. The method of claim 6, further comprising sending an execution result as a DNS response back to said client.

8. The method of claim 7, wherein said handler invokes a service module in said application so as to execute said command, wherein said application server is hosted in a same computer system or in a different computer system as said C-DNS server.

9. A client-server system, comprising:
a client;
one or more standard DNS servers;
a C-DNS server;
an application server;
a DNS command; and
a handler, wherein said DNS command is routed to said C-DNS server via said one or more standard DNS servers, said C-DNS server is configured to pass a command contained in said DNS command to said handler so as to cause said application server to execute said command.

10. The client-sever system of claim 9, wherein said application server is configured to produce a result and to send said result back to said client as a DNS response.

11. The client-server system of claim 9, wherein said DNS command is in the same format as a standard DNS query and comprises a plurality of phrases separated from each other by a dot.

12. The client-server system of claim 9, wherein said DNS command contains a first piece of information and a second piece of information; said first piece of information configured to allow said DNS command to be routed to said C-DNS server and said second piece of information being a reference to said DNS command to be executed by said application server.

13. The client-sever system of claim 12, wherein said application server is a database server configured to query or update a database.

14. The client-server system of claim 9, wherein said application server is hosted in a same computer system or in a different computer system as said C-DNS server.

15. The client system of claim 1, which is distributed on a device.

16. The client system of claim 15, wherein said device is a piece of scientific equipment.

17. The client system of claim 15, wherein said device is a piece of machinery.

18. The client system of claim 15, wherein said device is a household appliance.

19. The client system of claim 1, which is hosted in a consumer electronic device.

20. The client system of claim 19, wherein said consumer electronic device is a mobile phone, PDA, GPS, music player or recorder, video player or recorder, or notebook computer.
